(19) United States
(12) Patent Application Publication
(10) Pub. No.: US 2018/0244365 A1
(43) Pub. Date: Aug. 30, 2018

(54) MODULAR UAV WITH MODULE IDENTIFICATION

(71) Applicant: Vantage Robotics, LLC, San Francisco, CA (US)

(72) Inventors: Tobin Fisher, San Francisco, CA (US); Johannes Becker Van Niekerk, Livermore, CA (US); Craig Janik, Palo Alto, CA (US)

(21) Appl. No.: 15/904,149

(22) Filed: Feb. 23, 2018

Related U.S. Application Data
(60) Provisional application No. 62/463,494, filed on Feb. 24, 2017.

(51) Int. Cl. B64C 1/06; B64C 39/02; B64D 47/08

(52) U.S. Cl. CPC B64C 1/069; B64C 39/024; B64C 2201/042; B64C 2201/108; B64C 2201/027; B64D 47/08

(57) ABSTRACT

A modular unmanned aerial vehicle (UAV) can include a main body and one or more peripherals configured to be removably attached to the main body. The main body can be configured to identify the peripheral, such as through the provision of an identifying signal on the provisional. The processor can cause the UAV to execute a function based at least in part on the identification of the attached peripheral, or by user interaction with the peripheral or another component of the UAV.

### CROSS-REFERENCE TO RELATED APPLICATIONS

This application claims priority to U.S. Provisional Application No. 62/463,494, entitled MODULAR UAV WITH MODULE IDENTIFICATION and filed on Feb. 24, 2017, which is hereby incorporated by reference in its entirety.

### BACKGROUND

### Technical Field

Embodiments described herein generally relate to modular UAVs, and more particularly, to improvements of interconnectivity of modular components.

### Description of the Related Art

The design of conventional unmanned aerial vehicles (UAVs) is characterized by a mostly fixed structure of components. Batteries can be connectorized and swappable, but are often enclosed within a larger housing that forces the use of only batteries of identical size and shape. Propellers and motors are usually fastened with screws and are therefore replaceable in case of failure or damage, but due to limitation of the overall fixed structure, the basic flight dynamics are highly constrained if not fixed. FIG. 1 shows a DJI Phantom quadcopter UAV that is representative of fixed UAV structure UAV structure. The propellers and motors may be replaceable, but the motor supports, legs, and battery configuration are fixed.

Yet there are many tradeoffs in the design of UAV thrust-generating subsystems. For example larger propellers tend to be more efficient and quieter, but have slower dynamic response and, are less convenient for packing and transporting the UAV compared to a system with smaller propellers. Another tradeoff example is that features to protect users from injury from accidental contact with rotating propellers impede airflow and therefore reduce the thrust-producing efficiency of the propellers. Protective structures in close proximity to the propellers also increase turbulence which increases propeller noise.

There are benefits to providing convenient modularity to components used in UAVs, including: increased impact survivability, increased safety, ease of adaptability, user upgradeability, decreased downtime due to damage of a specific module, and decreased warranty costs to the manufacturer. The affordance of adaptability is analogous to the use of interchangeable lenses on SLR cameras. For example there is a benefit to the user to be able to use multiple different rotor sets with the same fuselage in order to maximize the usage envelope with the minimum possible expense.

### SUMMARY

Some embodiments relate to a modular unmanned aerial vehicle (UAV), comprising a main body; a peripheral configured to be removably attached to the main body, the peripheral configured to provide an identifying signal; a processor disposed within the main body, the processor configured to: receive an identifying signal from an attached peripheral; and cause the UAV to execute a function based at least in part on the identifying signal received from the attached peripheral.

The peripheral can include an identifying component configured to generate or alter the identifying signal provided by the UAV. The identifying component can include an identification resistor having a resistance indicative of the peripheral. The identifying component can include a capacitor or inductor.

Some embodiments relate to a modular unmanned aerial vehicle (UAV), comprising a main body, comprising: at least one securement location for attaching a peripheral thereto, the securement location comprising mechanical and electrical connectors; a processor in electrical communication with the electrical connectors at the at least one securement location; a removable peripheral, the removable peripheral comprising: mechanical and electrical connectors for removably securing the removable peripheral to the main body at the at least one securement location using the mechanical and electrical connectors at the main body; and a signal generating component configured to provide or modify a signal to generate an identifying signal indicative of the removable peripheral.

The processor can be configured to execute flight control instructions based at least in part on the removable peripheral attached to the main body.

Some embodiments relate to a modular UAV comprising a fuselage, a peripheral separate from the fuselage, a means for removably attaching the peripheral to the fuselage, a means for the peripheral to generate a unique signal readable by the fuselage, a software function running on the fuselage that matches the unique signal with at least one functional parameter, and a flight controller software application that controls the flight of the UAV according to the at least one unique functional parameter.

Some embodiments relate to a modular UAV comprising a main body, a peripheral separate from the main body, a means for removably attaching the peripheral to the main body, a means for the peripheral to generate a unique signal readable by the main body, a software function that matches the unique signal with at least one functional parameter, and flight controller software executing a function on the UAV according to the at least one unique functional parameter.

Some embodiments relate to a modular UAV comprising a fuselage, a peripheral separate from the fuselage, means for removably attaching the peripheral to the fuselage, means for identifying the peripheral attached to the UAV, a processor disposed within the UAV and configured to correlate the identification of the peripheral with at least one functional parameter, and control the flight of the UAV according to the at least one functional parameter.

### BRIEF DESCRIPTION OF THE DRAWINGS

The disclosed aspects will hereinafter be described in conjunction with the appended drawings, provided to illustrate and not to limit the disclosed aspects, wherein like designations denote the elements.

FIG. 1 shows an isometric view of a fixed UAV quadcopter structure.

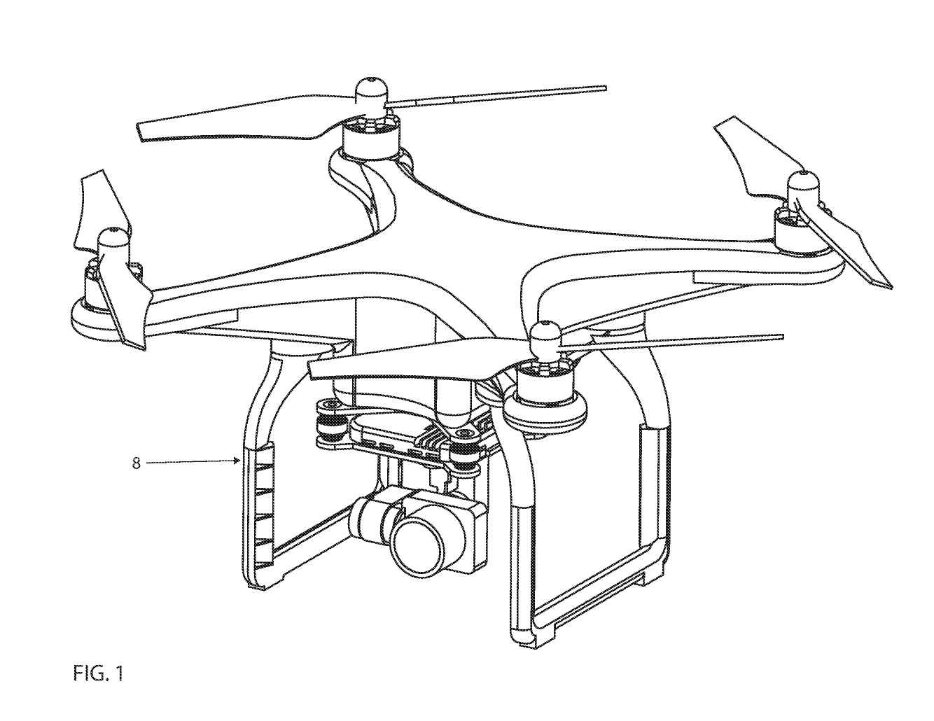

FIG. 2 shows an isometric view of a modular UAV including a pod with propeller protection.

FIG. 3 shows an exploded isometric view showing the various peripheral modules comprising the UAV.

FIG. 4 shows a view of the underside of the fuselage of the modular UAV.

FIG. 5 shows an isometric view of a rotor set mechanical and electrical interconnection assembly.

FIG. 6 shows a section view of a fuselage and a disconnected thrust pod mechanical and electrical interconnection assembly.

FIG. 7 shows a section view of a fuselage with a thrust pod connected.

FIG. 8 is a schematic diagram of a pod identification circuit.

FIG. 9 is an isometric view of a pod vibration isolation subsystem.

FIG. 10 is an isometric view of a fuselage attached to a rotor set that is optimized for endurance and quiet flight.

FIG. 11 is an isometric view of a rotor set optimized for speed and responsiveness.

FIG. 12 is an isometric view of a UAV with a Lidar backpack peripheral module.

FIG. 13 is an isometric view showing the attachment mechanism of a roof rack peripheral.

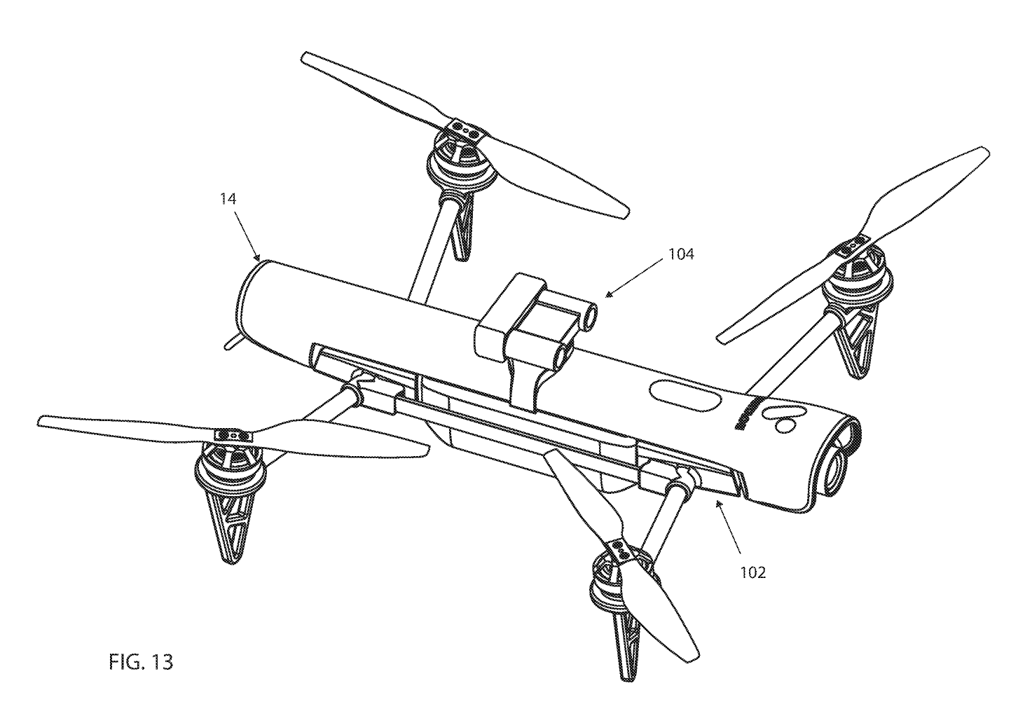

FIG. 14 is an isometric view showing a backpack peripheral module in an opened and closed state.

### DETAILED DESCRIPTION

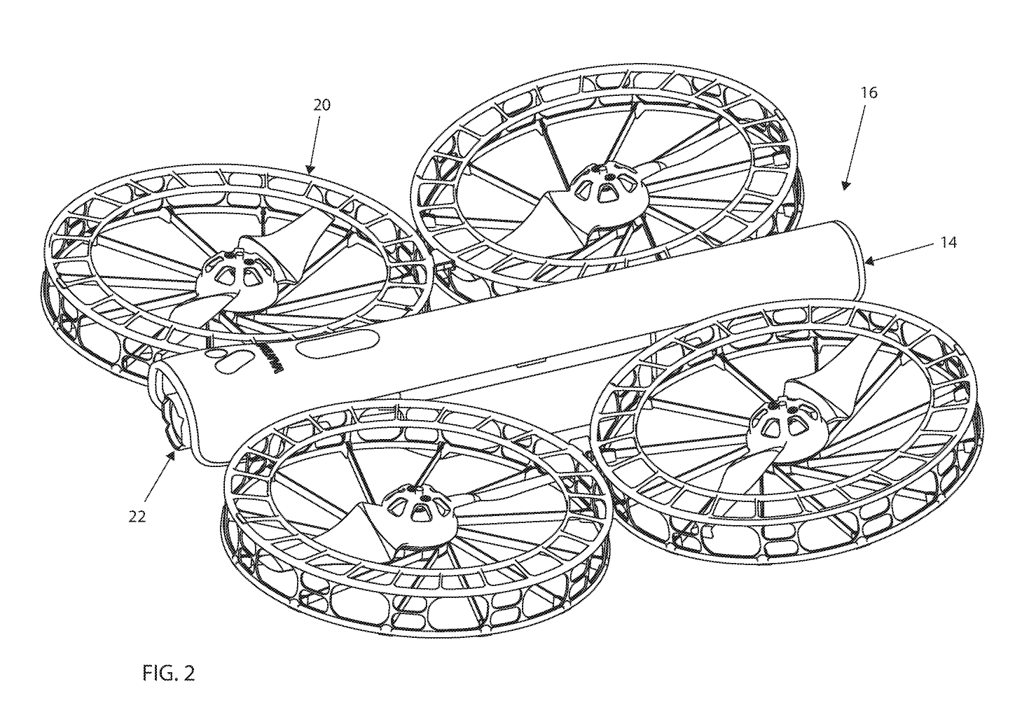

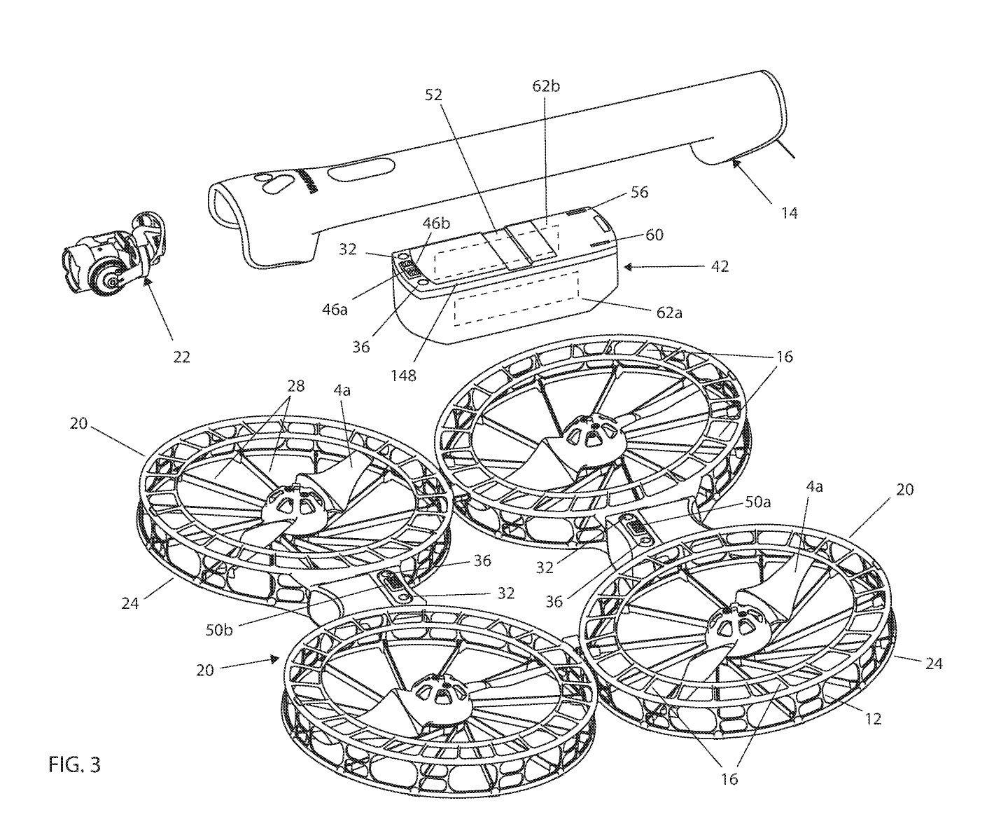

Described herein are embodiments of an unmanned aerial vehicle (UAV) 16 modular connection system that broadly provides an interchangeable mechanical and electrical interconnection between a peripheral module 12 and a main body 10. FIG. 2 and FIG. 3 show one embodiment of UAV 16 that includes a main body 10 that is a fuselage 14, a peripheral module that is a safety rotor set 20, a peripheral module that is a camera gimbal 22, and a peripheral module that is battery 42.

Main body 10 encloses a flight control processing subsystem 46 that includes a microprocessor 40 and several additional components, including motor controllers, radio-frequency communication circuitry, various sensors and non-volatile memory not specifically depicted herein.

### Rotor Set Peripheral Modules

Safety rotor set 20 is an electro-mechanical assembly used for the generation of controlled thrust for maneuvering UAV 16. In the illustrated embodiment, the safety rotor set 20 includes four motors 8 and two each of propellers 4a and 4b, and the requisite mechanical components for keeping motor 8—propeller 4 assemblies rigidly coupled in flight. Safety rotor set 20 is optimized for protection against accidental contact with rotating propellers 4. In the illustrated embodiment, the safety rotor set 20 includes protective structures, which may include four each of a perforated cylindrical rim 12, a plurality of top protective struts 16 that are integral to an injection molded pod top 20 component, and a plurality of structural and protective carbon fiber spokes 28 that are bonded to an injection molded pod bottom 24 component. In other embodiments, only some of these safety features may be included in a safety rotor set, or certain safety features may be included in addition to or in place other safety features described herein.

Safety rotor set 20 also includes electrical circuits, and electrical and mechanical connectors for attaching to fuselage 14. Safety rotor set 20 mechanical attachment subsystem includes a vibration isolation structure for minimizing the vibrational energy that is a by-product of the rotating propellers, from coupling to fuselage 14.

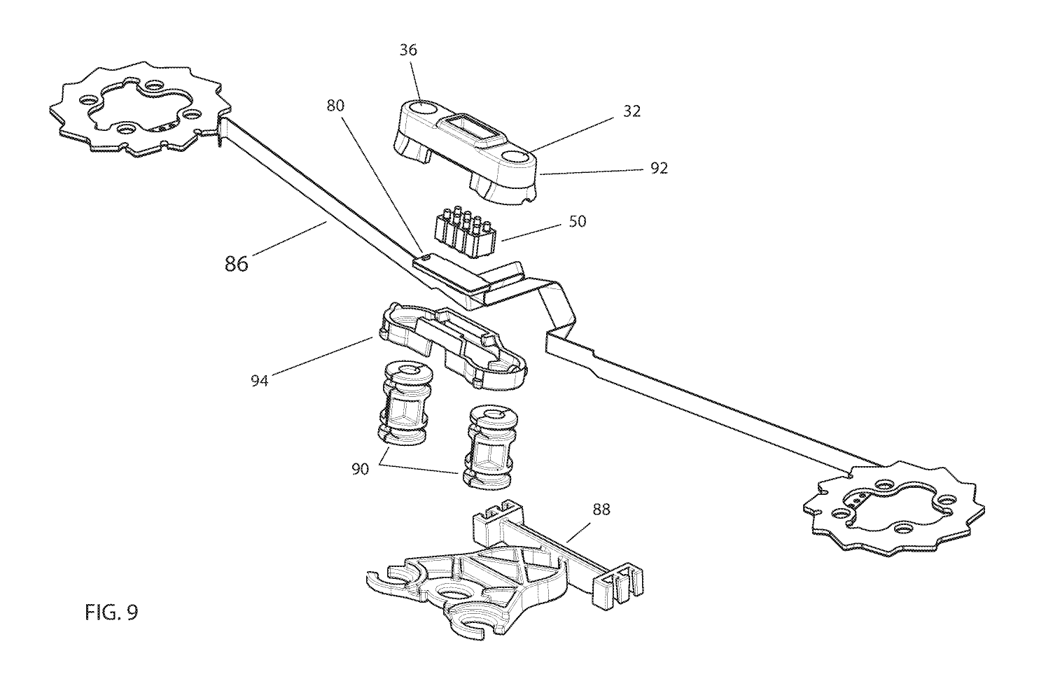

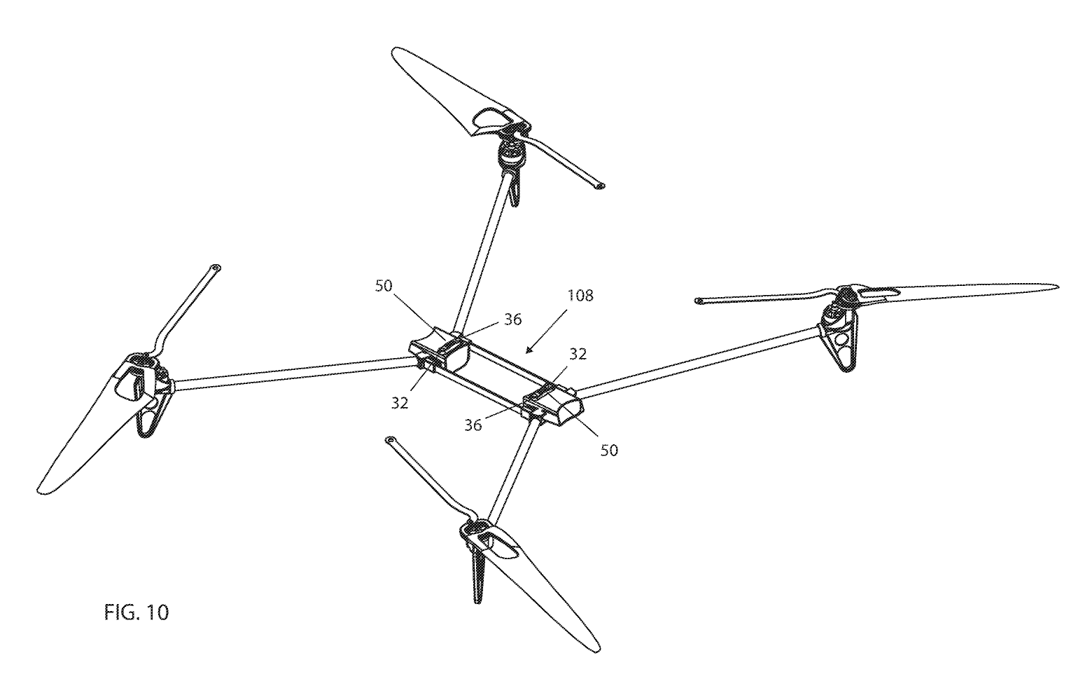

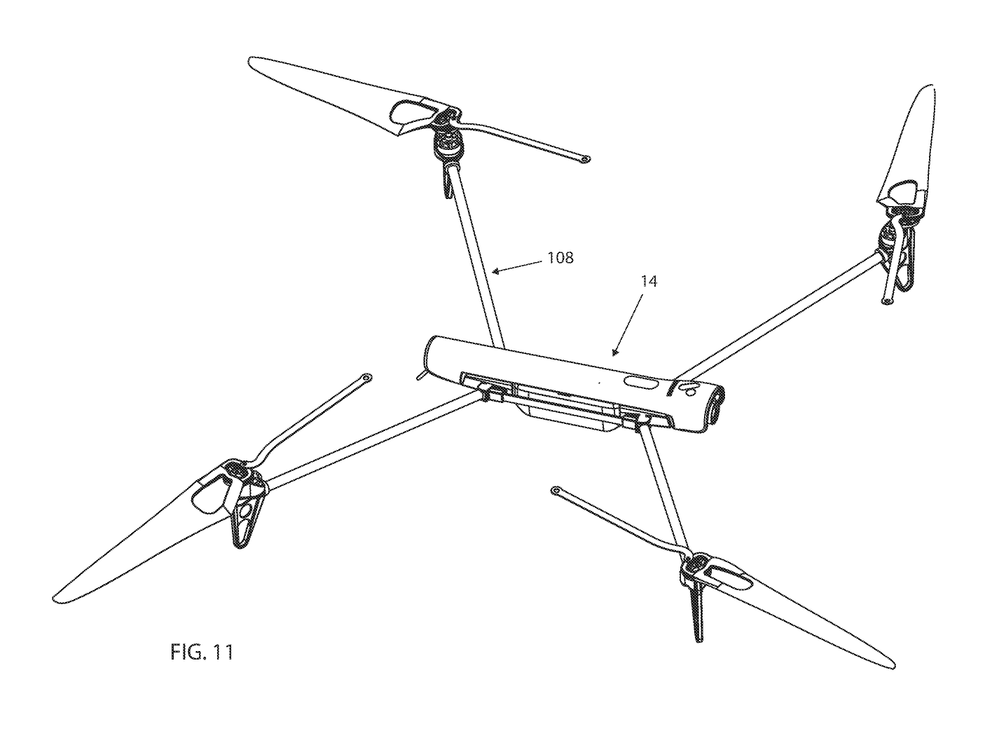

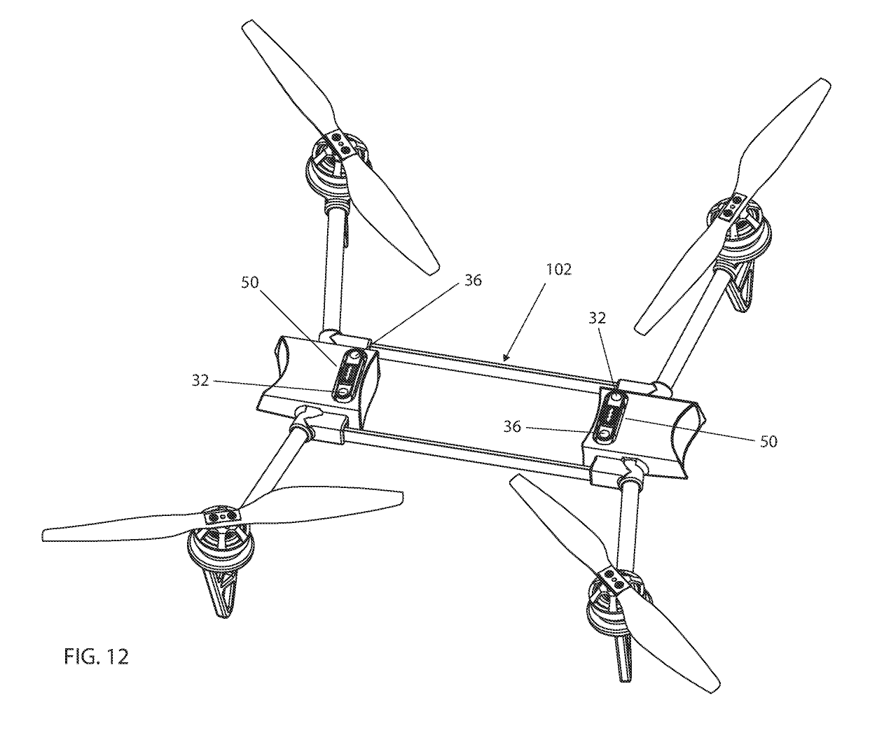

Although the mechanical attachment and vibration isolation subsystem, and electrical interconnection subsystems are described here in the context of safety rotor set 20, these subsystems may be common to the other rotor set peripherals described herein. Other embodiments of an optimized rotor set include a high-speed rotor set 102 shown in FIG. 11 and FIG. 12, and an endurance rotor set 108 shown in FIG. 9 and FIG. 10.

Optimized rotor sets are not limited to the embodiments shown here. For example, a rotor set could be designed to fold into a very small volume and would constitute a highly portable rotor set. Other examples include a general purpose rotor set, a rotor set that is designed for heavy lift, and a rotor set that is designed for high altitude.

### Battery Pack Peripheral Modules

FIG. 3 shows a rechargeable battery pack 42 that contains four 18650 size high output Lithium-ion cells and a power control subsystem, not depicted in detail herein. Battery 42 includes a capacitive sense subsystem and a digital communication link. Two capacitive sense electrodes 62a and 62b are adhered to or otherwise located adjacent to the inner walls of battery 42 enclosure. When battery 42 is attached to fuselage 14, an identifying digital message is sent to microprocessor 54 via the digital communication link. Microprocessor 54 then enables various features associated with battery 42.

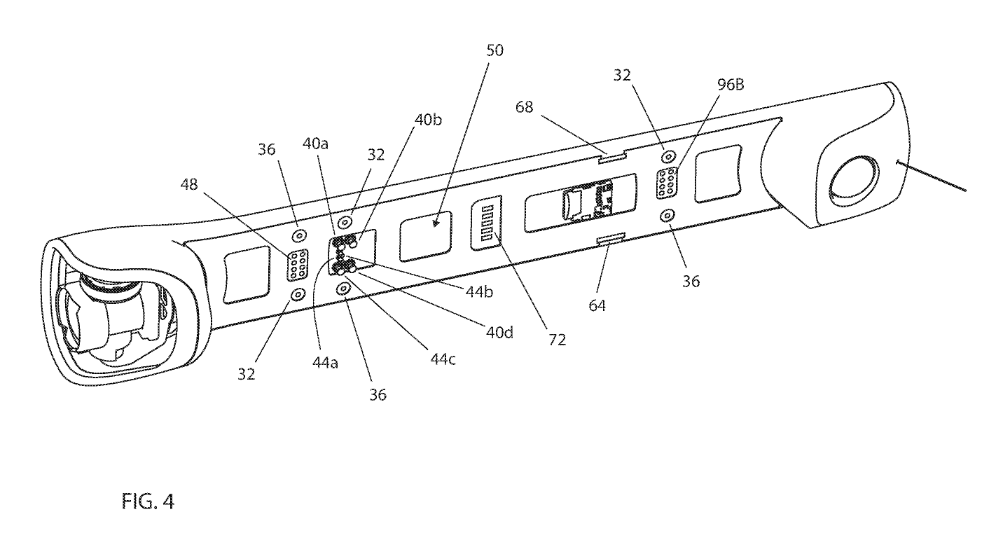

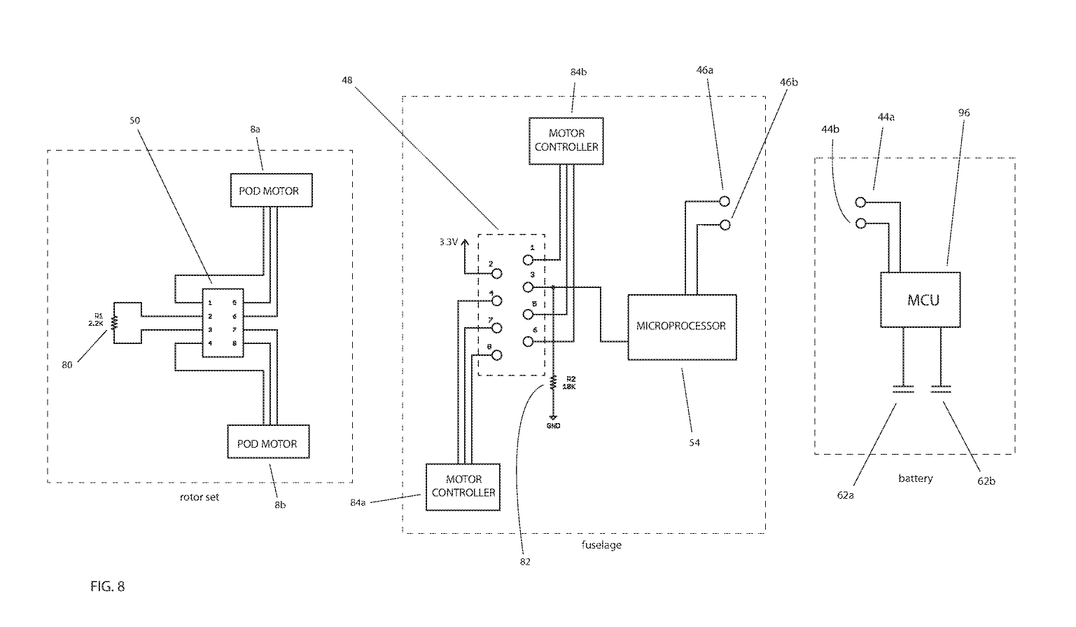

Referring now to FIG. 8, in one embodiment, a specific feature involves the function of capacitive sense electrodes 62a and 62b, which are functionally connected to an MCU 96 inside battery 42. When a user touches battery 42, MCU 96 sends a message to microprocessor 54 in fuselage 14, via the digital communication system, which is an I²C bus in this embodiment. Referring now to FIG. 3, FIG. 4, and FIG. 8, fuselage includes two battery signal contacts 46a and 46b that are electrically connected to the I2C bus in fuselage 14. Battery 42 includes two spring loaded contacts 44a and 44b that are electrically connected to the I2C bus in battery 42. Contacts 46a and 46b connect to spring contacts 44a and 44b when battery 44 is attached to fuselage 14.

In one embodiment, the combination of sensors and programming described above provides a user interface feature whereby the user can power down UAV 14 simply by holding and rotating UAV 14. On one embodiment, this feature functions as follows. When the user holds the UAV with their palm over the top of fuselage 14 with their fingers and thumb extending down the sides of battery 42, cap sense sensors 62a and 62b are triggered and a signal is sent from MCU 96 to microprocessor 54. When the user rotates UAV about the yaw axis, an IMU in fuselage 14 that is connected to microprocessor 54 senses the rotation and a signal is communicated to microprocessor 54. Firmware running on microprocessor 54 executes an algorithm and if the yaw rotation and angle are within a specific threshold, microprocessor 54 turns off power to motors 8a-d.

This above embodiment demonstrates how a battery peripheral may include unique features that trigger specific functions that require identification and communication with main body 10. For example in another embodiment a battery pack may include high power LEDs that allow UAV 16 to be identified at a distance or in low light. In another embodiment, a battery may have integral or deployable landing gear that would require UAV 16 to alter its rate of velocity in an automated ground landing process.

### Backpack Peripheral Modules

The function of UAV 16 may be enhanced by attaching peripheral modules beyond rotor sets or batteries. Referring again to FIG. 4, a backpack expansion port 72 is shown. Backpack port 72 includes a Universal Serial Bus (USB) 2.0 standard interface that provides power and communication capability. Port 72 also includes a USB switch, VBattery, I²C, and UART signal contacts. Backpack peripherals may include or provide additional sensors, processing capability, actuators, communications hardware or communications formats, or other capabilities. Example peripherals include a Lidar Obstacle-Avoidance module 104, cellular modem module 112, a DSM controller module, a combined cellular+DSM module, an illumination module, and a sky writer module (which is capable of writing letters and symbols in air using smoke), a speaker module, and a payload carry/drop module.

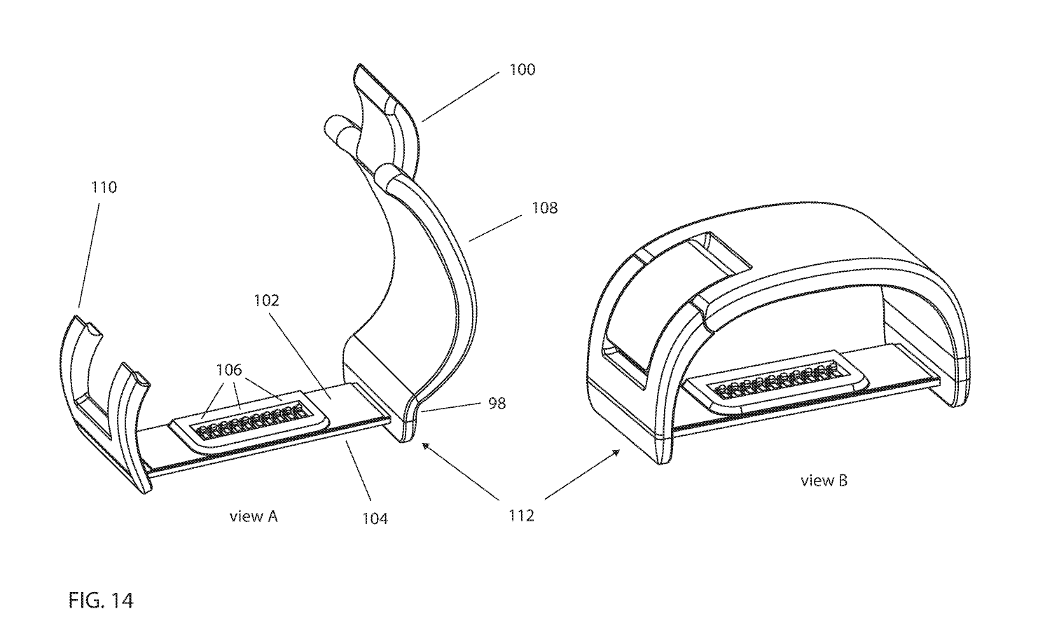

One embodiment of a backpack peripheral is a cellular data modem 112 shown in FIG. 14. There are two views, showing the two states of an over-center attachment mechanism for attaching backpack 112 to fuselage 14. View A shows that main enclosure 108 houses the cellular modem electronics (not shown), and is flexibly attached to a connector plate 102 via a flexible section 98, so that main enclosure 108 can rotate open to allow for placement onto fuselage 14. Flexible section 98 also includes an internal substantially non-stretchable Kevlar web (not shown) that connects main enclosure to connector plate 102. Connector plate 102 includes a thin circuit board onto which spring electrical contacts 106 are assembled. A thin but stiff carbon fiber plate 104 is laminated to connector plate 102 with epoxy. An over-center clamp 100 is rotatably attached to main enclosure. A clamp seat 110 is rotatably attached to the other side of connector plate 102.

View B shows backpack in the closed mode, as it would be attached around the mid-section of fuselage 14. FIG. 3 shows that battery 42 includes a backpack clearance slot 52 that provides clearance for backpack 112 connector plate 102.

### Peripheral Mechanical and Electrical Connection

Peripheral modules can make mechanical and electrical connections with main body 10 in a number of different ways. In some embodiments, the connection may be made with minimal effort for the user, and still be mechanically robust during UAV 16 flight. In embodiments of rotor sets and batteries described herein the mechanical connections can be made through the use of magnets and the electrical connections can be made through spring loaded electrical connectors 50. This offers the benefit of easy and fast connections when the user is preparing UAV 16 for operation, but with the ability to break away cleanly in the event of an unplanned impact. This breakaway functionality increases the overall durability of UAV 16 by reducing the energy that must be absorbed by each component.

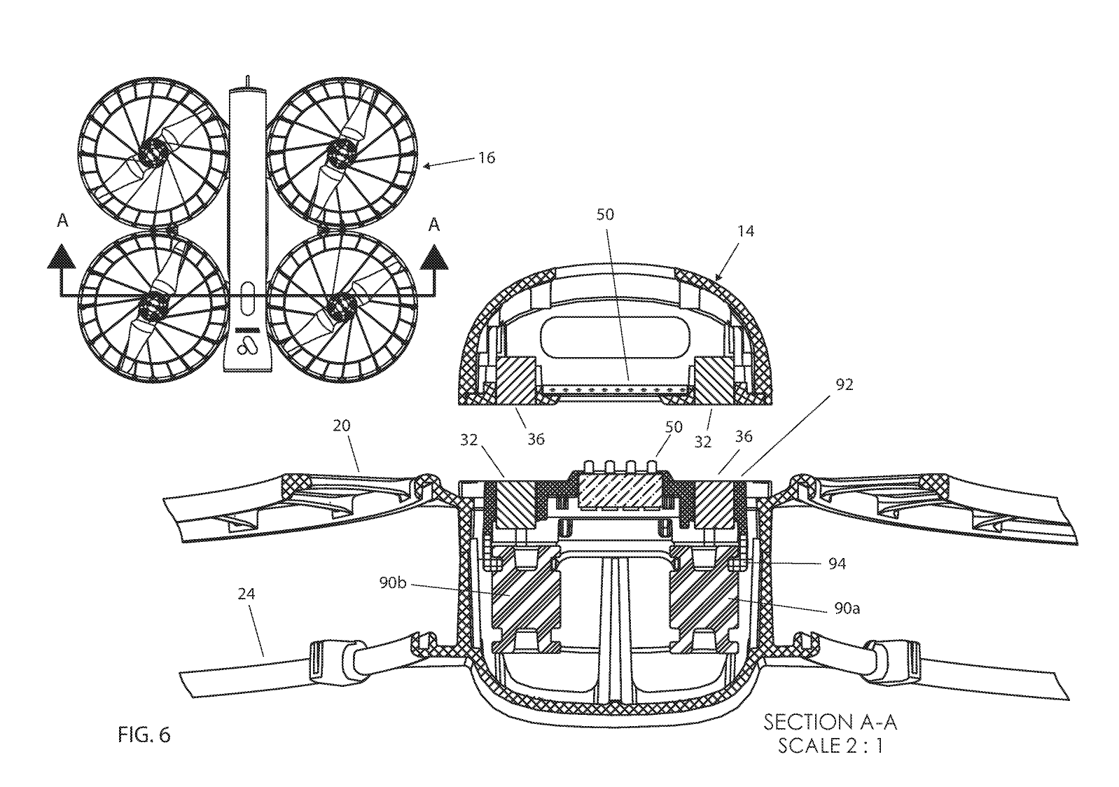

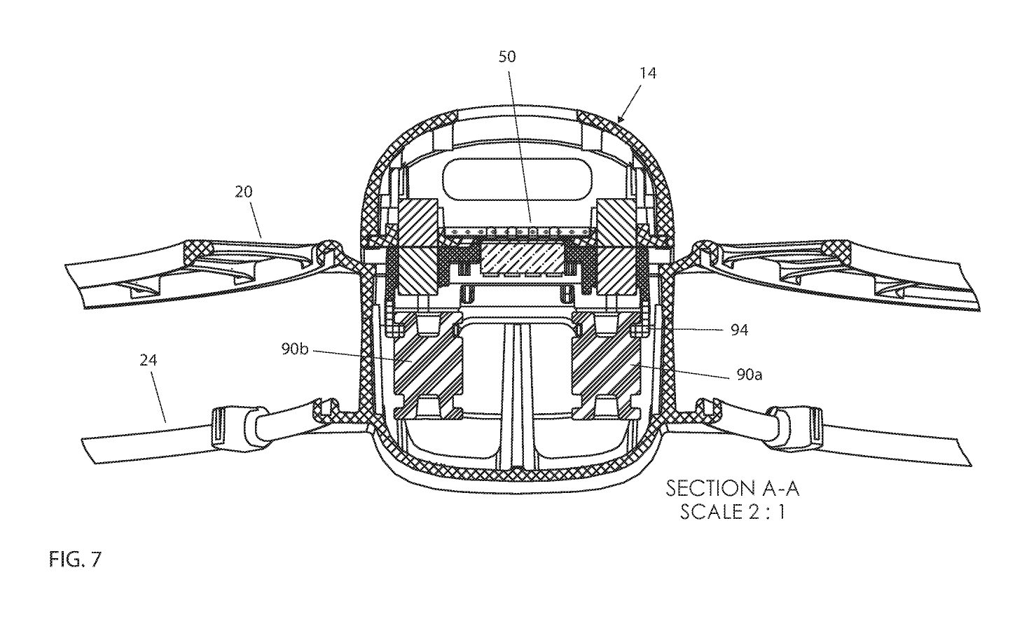

Referring now to FIG. 6 and FIG. 7, a cross-section view of peripheral mechanical and electrical connections is shown. FIG. 6 shows a cross-section with fuselage 14 and rotor set 20 disconnected. Many components in fuselage 14 are not shown so as not to obscure the features of the illustrated embodiments. Cylindrical magnets 32 and 36 are identical and are enumerated differently only to designate the orientation of the respective magnetic fields. To provide the magnetic attachment force, magnet 32 is used in fuselage 14 and magnet 36 is apositioned in rotor set 20. Likewise for magnet 36 in fuselage and magnet 32 in rotor set 20. In one embodiment magnet 32 and magnet 36 are fastened with epoxy into cylindrical magnet bosses in pod connector top 92 in rotor set 20, and into cylindrical magnet bosses in fuselage 14.

FIG. 6 and FIG. 7 show that spring pin connector module 50 is clamped by pod connector top 92 and pod connector bottom 94, which may be fastened together with epoxy. Pod connector bottom 94 is attached to dampener 90a and 90b, which is in turn attached to isolation flexure 88. Spring pin connector 50 may be soldered to motor flexible circuit 86. The configuration of these components is also shown in FIG. 9, an exploded view of the pod mechanical and electrical components.

FIG. 7 shows the section view with fuselage 14 and rotor set 20 attached. Corresponding magnets 32 and magnets 36 engage and accurately align rotor set 20 with fuselage 14. Rotor set 20 is designed so that spring pins 50 displace and compress firmly against plated contacts 40 on motherboard 50, also shown in FIG. 4, making a reliable electrical connection.

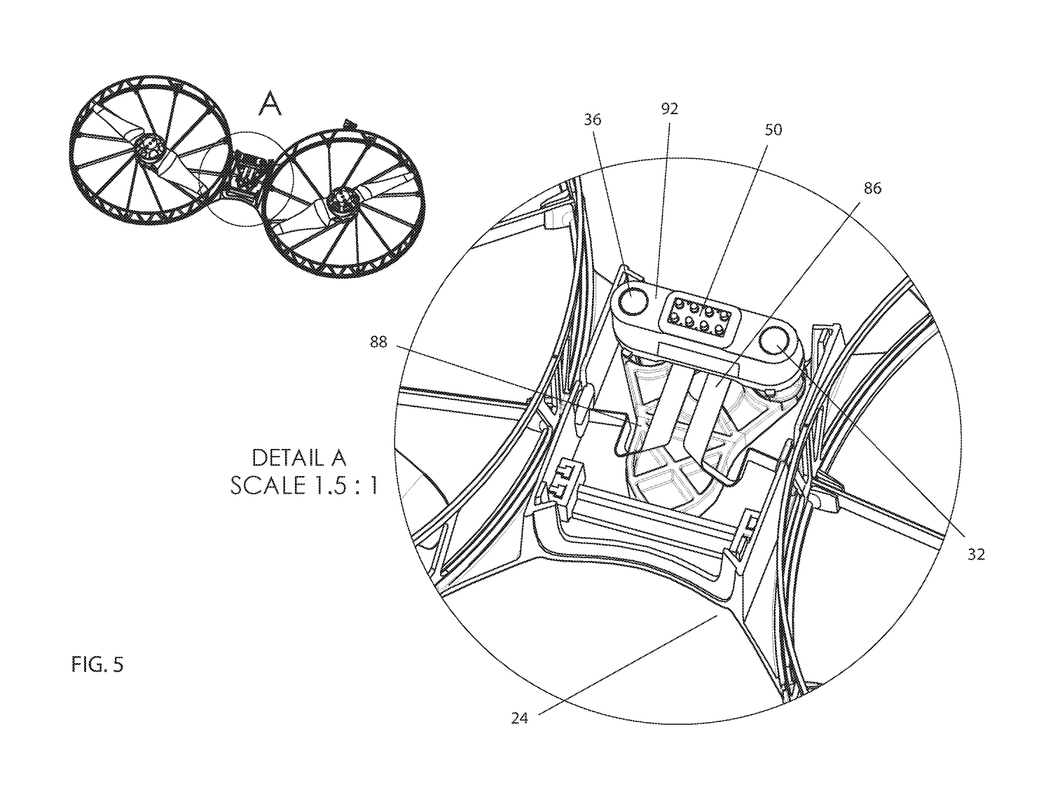

FIG. 5 and FIG. 9 show that motor flexible circuit 86 electrically connects spring pin connector 50 to motors 8. Pod connector bottom 94 is coupled to isolation flexure 88, which is dynamically bendable during flight. Motor flexible circuit 86 is a laminated polyimide circuit that is thin and compliant. An additional length of motor flexible circuit 86 is shaped in a bend inside pod bottom 24, and is a compliant service loop and provides minimal mechanical resistance to the system as isolation flexure 88 flexes dynamically during flight.

### Peripheral Identification

Peripherals 12 and main body 10 are designed so that peripherals communicate a unique identity to main body 10 so that a flight control processing subsystem 46 in main body 10 can alter the operation of software, values off onboard parameters, or user interfaces as appropriate for the new or different capabilities specific to each peripheral. For example, should high-speed rotor set 102 be attached to fuselage 14, upon detection and identification, the flight controller 46 will change the sensitivity of the input controls to better match the performance characteristics of the newly attached rotor set 102. This customization of parameters for a specific peripheral is but one of example of many that may occur for a specific peripheral.

Referring to FIG. 9, rotor set 20 includes a motor flexible circuit 86 that electrically connects motors 8 to spring pin module 50. Referring now to FIG. 8 and FIG. 9 motor flex circuit includes a pod identification resistor 80 as part of a voltage divider circuit that is used to produce a voltage that is connected to a I/O port on microprocessor 54. In this embodiment pod resistor 80 has a value of 2.2K ohms. Different pod models will include a different value resistor. Therefore this design is a simple and function method for uniquely identifying a specific peripheral. In another embodiment, a capacitor or inductor is used to provide a unique electrical characteristic in a simple circuit.

In the embodiment of battery 42 peripheral where a digital communication bus is used, an identifying number or alphanumeric code is stored in an EEPROM memory in MCU 96. The code may include a plurality of identifying sub-codes that are decoded by microprocessor 54 in combination with a lookup table that associates each sub-code with a function or feature software sub-routine.

Peripheral identification data identifies a specific peripheral model, but it may also identify a specific manufactured instance of a peripheral, for example a serial number. This number may then be used to track the lifespan, geographic location, or other pertinent aspects of the peripheral.

There are other methods for providing identification of peripheral modules. In another embodiment, a peripheral module is identified by using microprocessor 54 on main body 10 and an optical reading device (not shown) to read an optical ID code located on an attached peripheral module to determine the identity of the attached peripheral module.

In another embodiment, a peripheral module is identified using microprocessor 54 on main body 10 and a hall-effect sensor or a magnetometer (not shown) to read a magnet of specific known strength, orientation and number, located on an attached peripheral module. In the case of a magnetometer, magnetometer offsets can be used to measure unique parameters of a magnet or certain types of metals present or not present on the UAV at any given time. Changes in magnetometer offsets or measured values can be used to detect unique magnetometer signatures, which in turn, can be used to the identity of a specific attached peripheral module.

In another embodiment a peripheral module is identified using microprocessor 54 on main body 10 and an infrared (IR) range sensing device to measure the specific and predetermined depth of a bore formed within the housing of an attached peripheral module to determine the identity of the attached peripheral module.

In yet another embodiment a peripheral module is identified using an NFC tag (not shown) embedded in the peripheral module. Main body 10 includes an NFC antenna feature integral to motherboard 50, or as an additional low cost printed circuit component located in main body 10.

In another embodiment a peripheral module is identified using microprocessor 54 on main body 10 and an array of mechanical switches to effectively read an array of projections (bumps) provided on the housing of an attached peripheral module.

In another embodiment microprocessor 40 on main body 10 to read and analyze specific flight handling and performance characteristics of the UAV in flight, to determine the identity of a specific attached rotor set, since each type of rotor set will have unique flight handling and performance characteristics. Microprocessor 54 can use proportional-integral-derivative feedback information to calculate error value between a set-point and a measured process variable. This information can then be used to identify a signature that is unique to specific rotor set. Alternatively, different flight time prediction algorithms can be used to identify specific flight characteristics, which in turn may be used to identify which rotor set is currently attached to the fuselage.

In some embodiments, a “handheld” mode is provided which allows the user to simply hold the fuselage in their hand without any rotor sets attached. In this mode, flight of the UAV is not possible (since no rotor sets are attached), but a camera attached to the front of the fuselage is still operational and allows the user to use the camera, while holding the fuselage in his or her hand. In this mode, appropriate software can be used to detect the absence of any attached rotor set and automatically activate the “handheld” mode. In such instance, microprocessor 54 will automatically activate the camera and related operational circuitry and systems and will change electronic image stabilization (EIS) parameters and effective range of the camera gimbal range of motion to benefit handheld camera use.

In some embodiments, appropriate software (in combination with the use of any of the above systems and devices for detecting the presence, identity, and absence of an attached peripheral component or module) can be used to change the operation of the UAV. For example, should it be determined that no rotor is attached to the fuselage, this feature can initiate a “sleep mode” for the operating systems, thereby conserving power. Various sensors, such as motion detectors (using onboard accelerometers and gyro sensors) and capacitance sensing systems and circuitry and other touch-type switches can be used to detect the handling of the fuselage or attached battery. In such instance that fuselage is moved (beyond a preset range of motion, or following a specific movement signature or pattern) or otherwise touched by a user, the software and microprocessor 54 will force the operational system out of sleep mode. Also, should a rotor set be attached to the fuselage during a sleep mode, the above-described detection systems will detect this and will in turn cause microprocessor 54 to wake the operational circuitry from sleep mode. It should be noted that during sleep mode, it is preferred that any magnetometer offset data will remain and will not be updated or reset.

### User Interface Changes Based on Peripheral

Once a specific peripheral module is attached to main body 10, it will be detected and identified if the main body 10 is powered. Depending on the identity and function of the attached module, another feature is provided by the certain embodiments that activates specific user interface elements displayed on the interface of the controller, for example, a smartphone (not shown). For example, if a “smoke writer” module is attached to fuselage 14, an entry window and an on-screen keyboard will appear on the display of the controller. These new features will allow the user to input a message that he or she wants the module to write in the sky during flight.

In some embodiments, UAV 16 includes components which allow it to connect with the Internet so that updates to onboard software can be provided from a remote server. Such updates may be in response to and provided to support newly available modules created after a particular UAV was purchased.

Although the above embodiments have been described in connection with a UAV having four rotors (i.e., a quadcopter), it should be understood that the inventions disclosed in this application may be equally applied to any UAV, regardless of the number or configuration of rotors.

In the foregoing description, specific details are given to provide a thorough understanding of the examples. However, it will be understood by one of ordinary skill in the art that the examples may be practiced without these specific details. Certain embodiments that are described separately herein can be combined in a single embodiment, and the features described with reference to a given embodiment also can be implemented in multiple embodiments separately or in any suitable subcombination. In some examples, certain structures and techniques may be shown in greater detail than other structures or techniques to further explain the examples.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A modular unmanned aerial vehicle (UAV), comprising:
a main body;
a peripheral configured to be removably attached to the main body, the peripheral configured to provide an identifying signal;
a processor disposed within the main body, the processor configured to:
receive an identifying signal from an attached peripheral; and
cause the UAV to execute a function based at least in part on the identifying signal received from the attached peripheral.

2. The UAV of claim 1, wherein the peripheral comprises an identifying component configured to generate or alter the identifying signal provided to the UAV.

3. The UAV of claim 2, wherein the identifying component comprises an identification resistor having a resistance indicative of the peripheral.

4. The UAV of claim 2, wherein the identifying component comprises a capacitor or inductor.

5. The UAV of claim 1, wherein the peripheral comprises a plurality of rotors.

6. The UAV of claim 5, wherein each of the plurality of rotors comprises a protective structure at least partially shielding the rotor.

7. The UAV of claim 1, additionally comprising a plurality of mechanical and electrical connectors for removably securing the removable peripheral to the main body at a securement location.

8. The UAV of claim 1, wherein the peripheral comprises at least one sensor for sensing manipulation of the peripheral or UAV, wherein the UAV is configured to execute a function based at least in part on sensed manipulation of the peripheral or UAV.

9. A modular unmanned aerial vehicle (UAV), comprising:
a main body, comprising:
at least one securement location for attaching a peripheral thereto, the securement location comprising mechanical and electrical connectors;
a processor in electrical communication with the electrical connectors at the at least one securement location;
a removable peripheral, the removable peripheral comprising:
mechanical and electrical connectors for removably securing the removable peripheral to the main body at the at least one securement location using the mechanical and electrical connectors at the main body; and
a signal generating component configured to provide or modify a signal to generate an identifying signal indicative of the removable peripheral.

10. The modular UAV of claim 9, wherein the processor is configured to execute flight control instructions based at least in part on the removable peripheral attached to the main body.

11. The modular UAV of claim 9, wherein the removable peripheral comprises a rotor set.

12. The modular UAV of claim 11, wherein the rotor set comprises a plurality of protective structures configured to shield the rotors of the rotor set from mechanical interference.

13. The modular UAV of claim 11, wherein the rotor set comprises a plurality of rotors configured to reduce noise generated by the UAV.

14. The modular UAV of claim 11, wherein the rotor set comprises a plurality of rotors configured to increase the operating efficiency of the UAV.

15. A modular UAV comprising:
a fuselage,
a peripheral separate from the fuselage,
means for removably attaching the peripheral to the fuselage,
means for identifying the peripheral attached to the UAV,
a processor disposed within the UAV and configured to:
correlate the identification of the peripheral with at least one functional parameter, and
control the flight of the UAV according to the at least one functional parameter.

16. The modular UAV of claim 15, wherein the means for removably attaching the peripheral to the fuselage comprise magnets supported by the fuselage of the UAV.

17. The modular UAV of claim 15, wherein the means for identifying the peripheral attached to the UAV comprise a processor configured to receive an identifying signal from the attached peripheral.

18. The modular UAV of claim 17, wherein the peripheral comprises a signal generating component configured to provide or modify a signal to generate the identifying signal.

19. The modular UAV of claim 15, wherein the peripheral comprises a rotor set.

20. The modular UAV of claim 19, wherein the rotor set comprises a plurality of protective structures configured to shield the rotors of the rotor set from mechanical interference.
